(19) United States
(12) Patent Application Publication
(10) Pub. No.: US 2004/0214492 A1
(43) Pub. Date: Oct. 28, 2004

(54) Hybrid microporous membrane

(76) Inventor: Joel D. Martz, Lawrence, NY (US)

Correspondence Address: DAVID M. WARREN, 655 OAKLAND AVE., CEDARHURST, NY, 11516, US

(21) Appl. No.: 10/830,176

(22) Filed: Apr. 21, 2004

Related U.S. Application Data
(60) Provisional application No. 60/464,561, filed on Apr. 22, 2003.

(51) Int. Cl. B32B 3/00

(52) U.S. Cl. 442/59; 428/304.4

(57) ABSTRACT

A construction of breathable film upon a membrane with pores or passages that extend through the porous membrane enables the membrane to maintain a moisture vapor transport, namely, to be breathable, while the breathable film on the surface of the porous membrane serves as a barrier to the ingress of unwanted liquids. In the porous membrane, the diameter of an individual one of the pores is sufficiently small so as to enable the porous membrane to support a section of a reduced-thickness breathable film extending across openings of the pores without rupturing the breathable film.

### RELATED APPLICATION

This application is based on and claims right of priority in a provisional patent application having Ser. No. 60/464,561, filed Apr. 22, 2003.

### BACKGROUND OF THE INVENTION

This invention relates to moisture vapor permeable membranes and, more particularly, to microporous membranes, which are altered by a coating to enhance penetration and/or permeation resistance against liquids and/or gases, while maintaining still meaningful moisture vapor transmission.

A breathable membrane or film is permeable to water vapor but impervious to liquid water, and may be impervious also to other liquids including toxic biological fluids. In many applications wherein there may be danger of tearing the film, such as in bandage or article of clothing, the film may be supported upon a substrate of a nonwoven fabric, or scrim or a thicker apertured film that is laminated to the breathable film. However, even with the support of the substrate, the breathable film must be thick enough to have inherent strength to insure its integrity while being handled by a person. A greater thickness of the breathable film increases the cost of the finished product of breathable film plus supporting substrate, while a reduction in the thickness of the breathable film results in a reduction of the cost. In presently available products fabricated with breathable film, the film thickness is often greater than that which is necessary to provide the required breathability plus resistance to penetration of unwanted fluids. The increased cost may be prohibitive to use of a breathable film in a situation requiring a large area of the film, as in the construction of the backing a carpet.

### SUMMARY OF THE INVENTION

The aforementioned disadvantage is overcome and other benefits are provided by a construction of breathable film with a supportive backing layer, wherein the nature of the backing layer permits use of a breathable film having a reduced thickness, with a consequential reduction in cost of the finished product. In accordance with the invention, the backing layer is itself a membrane with pores or passages that extend through the porous membrane so as to enable the membrane to maintain a moisture vapor transport, namely, to be breathable, while the breathable film on the surface of the porous membrane serves as a barrier to the ingress of unwanted liquids. In the porous membrane, the diameter of an individual one of the pores is sufficiently small so as to enable the porous membrane to support a section of the reduced-thickness breathable film extending across an opening of the pore without rupturing the breathable film. In a preferred embodiment of the invention, the breathable film is applied as a coating to a microporous membrane to augment a liquid penetration resistance of the membrane while maintaining transport of moisture vapor through the coating and the membrane.

### BRIEF DESCRIPTION OF THE DRAWING

The aforementioned aspects and other features of the invention are explained in the following description, taken in connection with the accompanying drawing figures wherein:

FIG. 1 is a photomicrograph of the combination of breathable film supported on a porous membrane, and constituting a hybrid microporous membrane in accordance with the invention; and

FIG. 2 shows diagrammatically a cross-sectional view of the hybrid microporous membrane supported on a section of substrate.

### DETAILED DESCRIPTION OF THE INVENTION

The invention accomplishes the enhanced protective abilities by applying to a microporous membrane a layer of solvent or water based polymeric compounds that that are film forming and/or hydrophilic, and that inherently retain moisture vapor transmission ability, breathability, when dried on top of or within the microporous structure of such membranes. It is well recognized that the protective ability of microporous membranes can be compromised by fluid penetration through aberrant oversized pores or by overcoming the Bubble Point Pressure of the pores of microporous membranes by, for example, lowered surface tensions in challenging liquids. Also, it is well understood that permeation of gases and molecules can take place through passage through the micropores. The coated “breathable” polymeric barrier or such added coated breathable film within or on top of the pores of the microporous membrane aids in enhancing permeation resistance as well. In a preferred mode of construction of the invention, wherein there is augmentation of the protective ability of the microporous membrane by application of the foregoing layer of solvent or water based polymeric compounds, the augmentation is accomplished by gravure or flexographic coating or similar thin gauge coatings such as air knife technology typically in the range of 1 to 10 microns and less than 40 microns in thickness. The microporous membrane with the foregoing augmentation may be referred to as a hybrid microporous membrane.

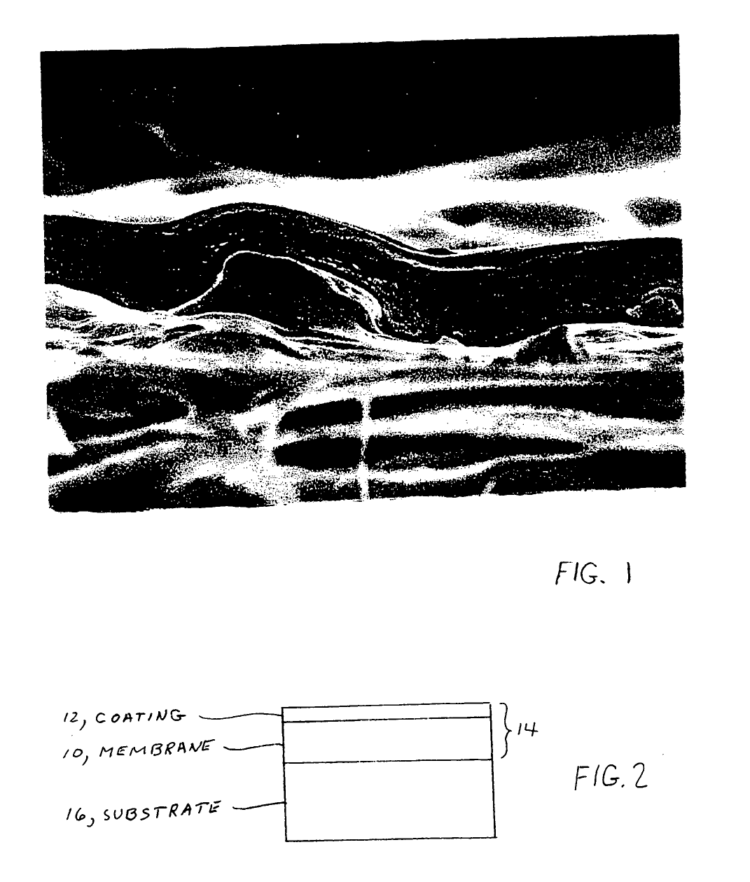

With reference to FIGS. 1 and 2, FIG. 1 shows a sectional view of a hybrid microporous membrane, wherein the darker part of the photomicrograph represents portions of the monolithic coating of the breathable film, and the lighter part of the photomicrograph represents portions of the microporous membrane. FIG. 2 shows the microporous membrane 10 as a middle layer with the coating 12 of the breathable film as a top layer adhering to the microporous membrane 10, wherein the top layer of the coating 12 and the middle layer if the microporous membrane 10 constitute the hybrid microporous membrane 14. The bottom layer in FIG. 2 represents a substrate 16, such as a layer of cloth, upon which the hybrid microporous membrane 14 may be mounted, by way of example, in the fabrication of a section of a fabric or garment.

In order to understand the physical-chemical principle of this invention, it is useful to review how microporous and other “Breathable” (Moisture Vapor Transmission) membranes such as monolithic membranes work. By way of example, in the case of an insect walking on the surface of a pond, there are powerful forces of surface tension supporting the weight of the insect on the liquid. The cohesive forces of water molecules in the presence of air create that supporting membrane-like surface at the air-water interface. Similarly, when one observes the movement of a water column moving upward in a capillary tube, this situation also demonstrates that same powerful phenomenon. Water trapped in the wetted mesh of a window screen is another common example of surface tension.

It is that same phenomenon of liquid supported and trapped by surface tension at the opening to air of the pores of a microporous membrane that prevents blood, chemicals and other liquids from passing through the pores. When fashioned or laminated into a substrate for protective apparel, sweat from the wearer, on the other hand, passes as vapor outward through the pores of the membrane because of the higher concentration of moisture on the body side compared to the relatively lower humidity in the air outside of the garment.

This phenomenon may be explained easily by the following formula:

BPP=4 ST (Cosine Theta)/D

where:

BPP=Bubble point pressure (the amount of pressure needed to break the surface tension at the air interface)

ST=The surface tension of the liquid

Cosine Theta=The wetting angle of the microporous membrane material

D=Diameter of the pore

From the principles presented above, it may be understood that the protective ability of a microporous membrane, such as the present microporous membrane considered alone without the breathable coating, may be compromised by lower surface tension liquids or by increasing pore size, such as may occur in aberrant oversized pores. Since most protective needs have penetration resistance quality that is measured, reliable protection to a standard must be assured or maintained. Moisture elimination, as explained previously by moisture vapor passage outward through pores, in many applications of such membranes, is a required continued simultaneous need. In order to provide the requisite protection against the ingress of unwanted fluids such as blood and other biological liquids or chemical agents, while maintaining the desired breathability, the present invention includes the coating of the breathable film disposed on the surface of the microporous membrane.

Therefore, the need for enhanced and more reliable penetration resistance or added permeation resistance is accomplished by forming a monolithic membrane or hydrophilic membrane, or film, within or on the surface (as the coating 12) of the microporous membrane 10. Monolithic membranes are usually continuous membranes or membranes with an ultra-microporous structure with pore sizes an order of magnitude smaller than the base microporous membrane. Their solid or much more compact structure explains its added penetration resistant ability. Outward moisture vapor occurs in solid membranes because of hydrophilic (water loving) polymers within some monolithic membranes which create a diffusion process for outward moisture transmission from wetter to drier conditions, such as outward sweat passage away from the body into the ambiance. Such liquid film forming compounds, used for forming the coating 12, are commercially available from companies such as Noveon Incorporated or Soluol Chemical. Other monolithic membranes are fully hydrophilic and others create ultra-microporous structures. Many are classified as cellulosic membranes.

In the construction of the hybrid microporous membrane 14 of the invention, the monolithic breathable membrane, or film, that serves as an augmenting layer on the microporous membrane, as the coating 12, or within the microporous membrane, as shown in FIG. 1, is applied as a liquid compound. A preferred method of application of the liquid compound is by gravure or flexographic coating or other thin gauge liquid application technology ideally capable of creating augmentation, the breathable film or coating 12, with a thickness in the range of 0.5-10 microns.

The quality of inherent liquid penetration resistance and augmented penetration resistance may be determined by test methods such as ASTM 903. The ability to measure broadened industrial chemical penetration resistances by chemical/liquid type following augmentation may be measured by comparing typical industrial chemicals pre-and post augmentation by selecting chemicals noted in ASTM 1001. The quality of resistance to blood and blood borne pathogens may be determined by test methods ASTM 1670 and 1671. Enhanced permeation resistance may be determined by test method ASTM 739. These are examples of typical standard test methods that may serve to evaluate protective qualities pre and post augmentation. Moisture Vapor Transmission Rates (MVTR) may similarly be evaluated pre and post augmentation by employing standard test methods such as ASTM E96.

In the case of liquid penetration testing, substrates that pass liquid penetration will fail with simple changes in surface tension. Plain Water, for example, with a Surface Tension of 73-dynes/cm will instantly become less than 40 dynes/cm with the simple addition of a few drops of surfactant, such as soap. Surgical Gown fabrics that contain microporous membranes will pass penetration tests with water at 73-dynes/cm surface tension but fail when exposed to blood that is about 43-dynes/cm. Isopropyl Alcohol has a surface tension of about 23-dynes/cm. Reducing pore sizes, in a microporous membrane, to overcome penetration resistance problems caused by low surface tension liquids simply reduces MVTR (Moisture Vapor Transmission Rates.)

A type of breathable membrane that prevents liquid penetration but allows for outward moisture elimination is the monolithic or solid membrane. This type of membrane is usually produced by extrusion or casting of soft and hard block polymers to produce a film which is liquid penetration resistant but allows moisture to pass through from a higher level of humidity to a lower level of humidity. Moisture is carried through the membrane like a “bucket brigade” by the soft block molecules. While highly effective in penetration resistance against many liquids and not subject, as a rule, to surface tension effects, monolithic membranes are based on polymer, with costs that are perhaps 10 times or more higher than most simple polyolefin microporous membranes.

In the case of Surgical Gowns and other protective garments, the augmentation process on the microporous membrane may be zoned in the substrate so that augmented protection may be provided to cover critical areas such as the chest or front and arms in surgical gowns as determined in the pattern while leaving areas of less protective criticality, such as sides or back, unaugmented often with higher MVTR desired in the unaugmented portion. The zoned augmented protection is accomplished by placing the coating of breathable material on the microporous membrane such that the coating extends over selected zones or portions of the microporous membrane of the garment while being absent in other zones or portions of the microporous membrane. The augmented membrane would be capable of passing ASTM 1670 and ASTM 1671 or similar Standards for Medical Products such as Surgical Gowns, and also would be capable of passing a testing for chemical penetration per ASTM 903 when tested with chemicals per ASTM 1001, Chemical Warfare/Terrorist Chemicals, and other Industrial chemicals used in agriculture. The augmented membrane exhibits improved permeation resistance as tested by ASTM 739 test or similar test for chemical objectives per ASTM 903 when tested with chemicals per ASTM 1001, Chemical Warfare/Terrorist Chemicals, and other Industrial chemicals used in agriculture. The augmented membrane exhibits improved penetration resistance as measured by ASTM 903 or similar Liquid Barrier Tests for blood and/or urine while maintaining moisture vapor transmission as used in Feminine Hygiene, Incontinence Products and Diapers.

In the construction of a preferred embodiment of the invention, the microporous membrane 10 is constructed of any one of polyethylene, polypropylene, polyurethane, PTFE (polytetrafluoroethylene), aramid, or nylon by way of example, with a typical mean pore size of 0.1-5.0 microns, and a membrane thickness in a range of 10-100 microns. The membrane 10 is thicker than the coating 12. The material of the coating 12 is applied in liquid or paste form and later dries upon evaporation of a solvent such as a polymer solvent, or possibly water. The coating material is a breathable polymer such as urethane or hydrophilic cellulose, and is applied to the membrane preferably by air knife technology or flexographic technique to insure a precise metering of the flow of the liquid coating material onto the membrane surface and/or absorption into pores of the membrane. It is noted that the pores, generally, are not extending straight through the membrane, but are dispersed and interconnected in various directions, much like the pores found in coral.

This description of the formation of the pores helps one understand the scanning electron micrograph, FIG. 1, which is a cross-sectional view of the membrane, In the micrograph, the darker part is the monolithic coating and the lighter part is the material of the microporous membrane. In accordance with the operation of the invention, the coating introduces a selective transport characteristic to water vapor and other liquids and gases in that, transport of the other liquids and of the gases is inhibited while the transport of the water vapor is enabled.

It is to be understood that the above described embodiments of the invention are illustrative only, and that modifications thereof may occur to those skilled in the art. Accordingly, this invention is not to be regarded as limited to the embodiments disclosed herein, but is to be limited only as defined by the appended claims.

What is claimed is:

1. A coated microporous membrane comprising a microporous membrane with a coating of breathable material which augments a liquid penetration resistance of the membrane while maintaining transport of moisture vapor.

2. A membrane according to claim 1 wherein the coating is a urethane polymer or a hydrophilic cellulose.

3. A membrane according to claim 2 wherein the membrane is any one of polyethylene, polypropylene, polyurethane, PTFE, aramid, or nylon.

4. A membrane according to claim 1 wherein the membrane is any one of polyethylene, polypropylene, polyurethane, PTFE, aramid, or nylon.

5. A membrane according to claim 1 wherein a mean pore size of the membrane is in the range of 0.1-5.0 microns, and the membrane has a thickness in the range of 10-100 microns.

6. A membrane according to claim 5 wherein the coating has a thickness in the range of 0.5-10 microns.

7. A membrane according to claim 5 wherein the thickness of the membrane is greater than a thickness of the coating.

8. A membrane according to claim 1 wherein augmentation of the liquid penetration resistance of the membrane by the coating of breathable material provides a capability of the membrane to pass ASTM 1670 and ASTM 1671 or similar Standards for Medical Products such as Surgical Gowns.

9. A membrane according to claim 1 wherein augmentation of the liquid penetration resistance of the membrane by the coating of breathable material provides a capability of the membrane to pass a testing for chemical penetration per ASTM 903 when tested with chemicals per ASTM 1001, Chemical Warfare/Terrorist Chemicals, and other Industrial chemicals used in agriculture.

10. A membrane according to claim 1 wherein augmentation of the liquid penetration resistance of the membrane by the coating of breathable material provides a capability of the membrane to exhibit improved permeation resistance as tested by ASTM 739 test or similar test for chemical objectives per ASTM 903 when tested with chemicals per ASTM 1001, Chemical Warfare/Terrorist Chemicals, and other Industrial chemicals used in agriculture.

11. A membrane according to claim 1 wherein augmentation of the liquid penetration resistance of the membrane by the coating of breathable material provides a capability of the membrane to exhibit improved penetration resistance as measured by ASTM 903 or similar Liquid Barrier Tests for blood and/or urine while maintaining moisture vapor transmission as used in Feminine Hygiene, Incontinence Products and Diapers.

12. A membrane according to claim 1 wherein the coating extends over a portion of the microporous membrane, while being absent in a further portion of the microporous membrane.

13. A hybrid microporous membrane comprising layers of material, disposed one upon another, wherein a first of said layers of material comprises a breathable film impeding passage of liquid water while communicating water vapor, and a second of said layers of material comprises a microporous membrane having pores extending through the microporous membrane with a mean pore size in the range of 0.1-5.0 microns, and wherein the breathable film has a thickness in the range of 0.5-10 microns.
